(19) United States
(12) Patent Application Publication
(10) Pub. No.: US 2013/0297451 A1
(43) Pub. Date: Nov. 7, 2013

(54) METHOD AND SYSTEM FOR PRODUCT OR SERVICE SOURCE AUTHENTICATION

(71) Applicants: Evgeny Lishak, Vaughan (CA); Sheldon Michael Gold, Toronto (CA)

(72) Inventors: Evgeny Lishak, Vaughan (CA); Sheldon Michael Gold, Toronto (CA)

(73) Assignee: 1856327 Ontario Corp., Toronto, ON (CA)

(21) Appl. No.: 13/993,610

(22) PCT Filed: Oct. 7, 2011
(86) PCT No.: PCT/CA11/01135

§ 371 Date: Jul. 25, 2013

(30) Foreign Application Priority Data
Dec. 16, 2010 (CA) 2726748

(51) Int. Cl. G06Q 30/06

(52) U.S. Cl. CPC G06Q 30/0609
USPC 705/26.35

(57) ABSTRACT

A method of providing proof of authenticity for an item of merchandise to the portable device of a potential buyer is disclosed. The method utilizes (i) affixing or embedding a token that provides a unique merchandise authentication code that is readable by the buyer's portable device (the code may be on a contactless microprocessor chip), (ii) including this merchandise authentication code in messages that comprise conventional card-based payment transactions, (iii) providing the potential buyer's portable device with data pertaining to the lifecycle status, authenticity, and description of the item of merchandise, (iv) displaying the data at the buyer's portable device, and (v) posting/recording the sale of the item of merchandise at the brandname lifecycle management host.

### FIELD

The present specification relates generally to computing devices and more specifically relates to a method and system for product or service source authentication.

### BACKGROUND

There are already existing methods of branded commodity authentication based on unique codes assigned to an item of merchandise. An example of such a method is certificates of authenticity affixed to computer software packaging. This method of item authentication carries the risk that a certificate (or tag or similar token) might be copied and affixed to counterfeit goods.

There are also known methods of online verification of information related to merchandise and their lifecycles by way of submitting unique codes to a lifecycle management database. The product activation key used by computer software manufacturers is an example of such a method. The main flaws in this method arise if the sale of the software is not reported or if there is never any contact (i.e. formal registration) required between the consumers computer and the lifecycle management system.

There are methods mitigating the above flaws in the methods above that involve the introduction of hidden, unpredictable authentication codes that are physically embedded in the merchandise or its packaging in such a way that the merchandise authentication code can only be revealed by destroying the product packaging after the product purchase is complete. An example of this type of method is found in US Patent Claim US 2008/0002882 A1. The main disadvantage of this cited method is that the authenticity of the merchandise can be proved only after the purchase. An additional disadvantage is the possibility that the hidden token might be copied without leaving evidence of tampering.

The invention disclosed below has none of the disadvantages cited above. This invention is based on the use of industry-proven Integrated Circuit Cards (ICC) with contactless interfaces (hereafter “contactless chips”). The contactless chip must be capable of proving its authenticity on demand. For example, the chip securely stores a certificate (credentials) issued by a trusted certificate authority known to the consumer's portable device and also possibly to the merchant's Point of Sale (POS) system. Contactless chips with authentication technology cannot be cloned.

For this invention, contactless chips are physically embedded into brand-protected merchandise in such a way that enables the authentication codes to be revealed by way of wireless communication with a portable device without the need to destroy either the packaging or any part of the item itself. Contactless chips can also be embedded in such a way that the contactless chip cannot be extracted without doing visible damage to either the merchandise or the chip itself.

Contactless chips are well known technology. Examples of contactless chips in card payment transaction processing are Visa® PayWave™ and MasterCard® PayPass™. Contactless chips appear in many form factors such as: key fobs and cell phone stickers. Irrespective of the form factor utilized in the implementation of this invention, the contactless chip securely stores the unique merchandise authentication code that can be presented to the merchant's POS system used to perform the purchase transaction.

### SUMMARY

Aspects of the present specification provide: (i) verification of the authenticity of an item of merchandise before the time of purchase by using information stored on the database of a lifecycle management system; (ii) a method of the verification whereby the verification results are delivered directly to the potential buyer's portable device.

An aspect of this specification provides a method of providing proof of authenticity for an item of merchandise to the portable device of a potential buyer. In this aspect, the method comprises (i) affixing or embedding a token that provides a unique merchandise authentication code that is readable by the buyer's portable device (the code may be on a contactless microprocessor chip), (ii) including this merchandise authentication code in messages that comprise card-based payment transactions, (iii) providing the potential buyer's portable device with data pertaining to the lifecycle status, authenticity, and description of the item of merchandise, (iv) displaying the data at the buyer's portable device, (v) requesting consent from the consumer to continue the purchase and (vi) posting/recording the sale of the item of merchandise at the brand name lifecycle management host.

Aspects of this specification provide methods of verification of merchandise authenticity comprising:

electronic methods of assuring the authenticity of merchandise

electronic methods of payment transaction processing

electronic methods relying on embedding an ICC into the merchandise or its packaging

electronic methods of presenting the proofs of authenticity directly to the potential consumer or purchaser of the merchandise and receiving the purchaser's consent based on a determination on the merchandise authenticity.

Aspects of this specification also provide methods of presenting proof of merchandise authenticity to the consumer purchasing the merchandise and receiving the purchaser's consent to proceed either at or prior to the time of purchase involving the following components:

a. the Contactless Chip, an unclonable, contactless integrated circuit card or simply a microprocessor chip physically embedded into a single item of merchandise or its packaging, carrying a Merchandise Authentication Code (MAC) uniquely identifying the item of merchandise, wherein “contactless” means having any contactless capability including but not limited to NFC, Bluetooth, infrared, and RFID;

b. the Payment Instrument, comprising all the technologies and related processes used by consumers to perform a payment transaction for the purchase of merchandise or services, for example: a payment card, whether privately issued or issued under the auspices of an issuer organization(e.g. MasterCard®), a software payment application (e.g. VISA® PayWave™), an electronic purse or wallet device;

c. the Point Of Sale (POS), a device, installed at the place of the merchandise sale, having contactless capability, compatible with both Contactless Chip and Payment Instrument;

d. the Service Provider, the aggregate technology, comprising (i) the payment network or other equipment providing and transaction routing capabilities required to perform payment transaction processing for the POS and Payment Instrument and (ii) the merchandise lifecycle management system, required to carry out brand protection and merchandise authentication processes;

e. the Smartphone, a portable computer device in form factors including but not limited to personal digital assistants, and cellular phones, having Internet access or other messaging capabilities and are physically held or carried by the consumer;

wherein the Smartphone, POS, and Service Provider communicate with each other and using information provided by the Contactless Chip and Payment Instrument perform the following set of actions in any order and if permitted by the implementation, in parallel:

(a) generate the payment transaction for the purchase of the item of merchandise;

(b) authenticate the item of merchandise and generate a determination of the authenticity of the item of merchandise;

(c) retrieve the both merchandise item lifecycle status and merchandise item description, and display this information and determination of authenticity (referred to as Merchandise Verification Data (MVD) elsewhere herein) on the Smartphone;

(d) update both the state of the item of merchandise and the payment transaction attributes in the Service Provider's merchandise lifecycle management database.

While not required, in certain implementations, the foregoing can be effected in such a way that the sale of an item of merchandise can only complete if and only if all the actions result in successful outcomes with respect to payment, item authentication and lifecycle database management and the end result of the authentication and authorization constituent processes is presented as a single outcome to the consumer.

Providing more particular features that can be used with the foregoing, a Tag can be utilized, as either a complement or substitute for the Contactless Chip, in the form of label, tag, or certificate, affixed, physically or logically, to the merchandise or merchandise packaging, and the Tag can carry a Merchandise Tag Code (MTC), uniquely identifying the item of merchandise and the MTC is an alphanumeric code or a barcode or both or the like that is displayed or encoded on the Tag;

b. the Smartphone or the Point of Sale can be capable of scanning or receiving the MTC by way of manual data entry including but not limited to keyboard entry or voice recognition methods;

c. either (i) the MTC is used instead of the MAC or (ii) MTC is used in addition to the MAC and there is a one-to-one relationship between the MTC and the MAC.

The MVD can be generated using the following data elements including but not limited to:

an indicator that the merchandise was shipped to the store associated with the POS performing the payment transaction and merchandise authentication transaction;

lifecycle information related to the state of the merchandise in the sales process (e.g. sold, shipped, for sale);

data items associated with determination that the merchandise, Contactless Chip, or the Unique Tag has neither been revoked nor is it the subject of an active fraud investigation.

The MVD can be displayed on a Smartphone, and additionally the following information can be displayed (recognizing that this is a non-exhaustive list):

the location of the store to which the merchandise was shipped;

the date when the merchandise was shipped to the store;

the date the merchandise was received by the store;

the serial number of the merchandise;

the colour, size, style, configuration, shape, and discrete components comprising a physical description of the merchandise.

The MVD can be displayed on the Smartphone several times during the course of the purchase including but not limited to: before check-out, during check-out, and after check-out, wherein some of the Smartphone display actions may require the user confirmation communicated to either the Smartphone, POS or both.

Several items of merchandise can be authenticated and an MVD for each item can be generated and displayed during the same payment transaction.

The POS can comprise virtual components, including but not limited to: virtual stores, auction sites, electronic shopping carts, call centres and web services;

The Payment Instrument and the consumer need not be physically present in a store with the merchandise at the time of purchase;

The payment transaction and merchandise authentication can be completed when the item of merchandise is physically delivered to the consumer;

The item of merchandise can be authenticated without being extracted from the packaging in which it was shipped to the consumer.

The Payment Instrument can be either logically associated with or physically integrated within the Smartphone.

The Contactless Chip can authenticate itself to the Smartphone using public or private key cryptographic techniques to validate the digital certificate of the chip. The Service Provider can execute the matching process using the data scanned by the Smartphone and the data captured by the POS and ensures that the same Contactless Chip was used in the purchase process.

The Contactless Chip can be replaced by a brand name-issued contactless payment card, having any form factor, embedded into the merchandise, and the embedded payment card, instead of a Contactless Chip, provides information to the POS and Smartphone. The transaction arising from the interaction of the POS and the card can be used for the purpose of authenticating the item of merchandise, and the transaction may be of any type including but not limited to purchase, balance inquiry or activation. The MAC or MTC can be the contactless payment card primary account number, or some other combination of payment application data derived from the card.

If the POS or Smartphone is incapable of communicating with the contactless payment card or Contactless Chip, or of scanning the Tag to capture the MTC, the MAC or MTC can be manually keyed into the respective device.

If the MAC or MTC is keyed to the POS, the Smartphone can be used to display the MAC or MTC which is scanned or otherwise captured by the Smartphone from the contactless payment card or Contactless Chip, or Tag.

As an alternative to keying in the MAC or MTC to POS, the Smartphone can capture and subsequently transmit a MAC or MTC to the POS.

In certain implementations, some or all messages are protected from disclosure or alteration by means including but not limited to: symmetric key encryption, public key encryption, message authentication codes, electronic digital certificates and electronic signatures.

### BRIEF DESCRIPTION OF THE DRAWINGS

FIG. 1 is a schematic representation of a brand name authentication and transaction processing system.

FIG. 2 shows a plurality of blocks that can be performed on the system of FIG. 1, where those blocks represent a method for brand name authentication and transaction processing that is embedded into a conventional payment card transaction.

FIG. 3 shows a plurality of blocks that can be performed on the system of FIG. 1, where those blocks represent a method for brand name authentication and transaction processing using a payment card as a contactless chip.

FIG. 4 shows a plurality of blocks that can be performed on the system of FIG. 1, where those blocks represent a method for brand name authentication and transaction processing using a contactless-incapable point of sale or contactless-incapable merchandise.

FIG. 5 shows a plurality of blocks that can be performed on the system of FIG. 1, where those blocks represent a method for brand name authentication and transaction processing in E-commerce environment.

FIG. 6 is a schematic representation of a brand authentication and transaction processing system.

FIG. 7 is a flow chart depicting a method for brand authentication and transaction processing.

FIG. 8 shows the system of FIG. 6 during example of performance of certain blocks of the method of FIG. 7.

FIG. 9 is a flow chart depicting another method for brand authentication and transaction processing.

FIG. 10 is a flow chart depicting another method for brand authentication and transaction processing.

FIG. 11 shows the system of FIG. 6 during example performance of certain blocks of the method of FIG. 10.

FIG. 12 shows an example data stream that can be prepared according to certain blocks in the method of FIG. 10.

FIG. 13 is a flow chart depicting another method for brand authentication and transaction processing.

### DETAILED DESCRIPTION OF THE EMBODIMENTS

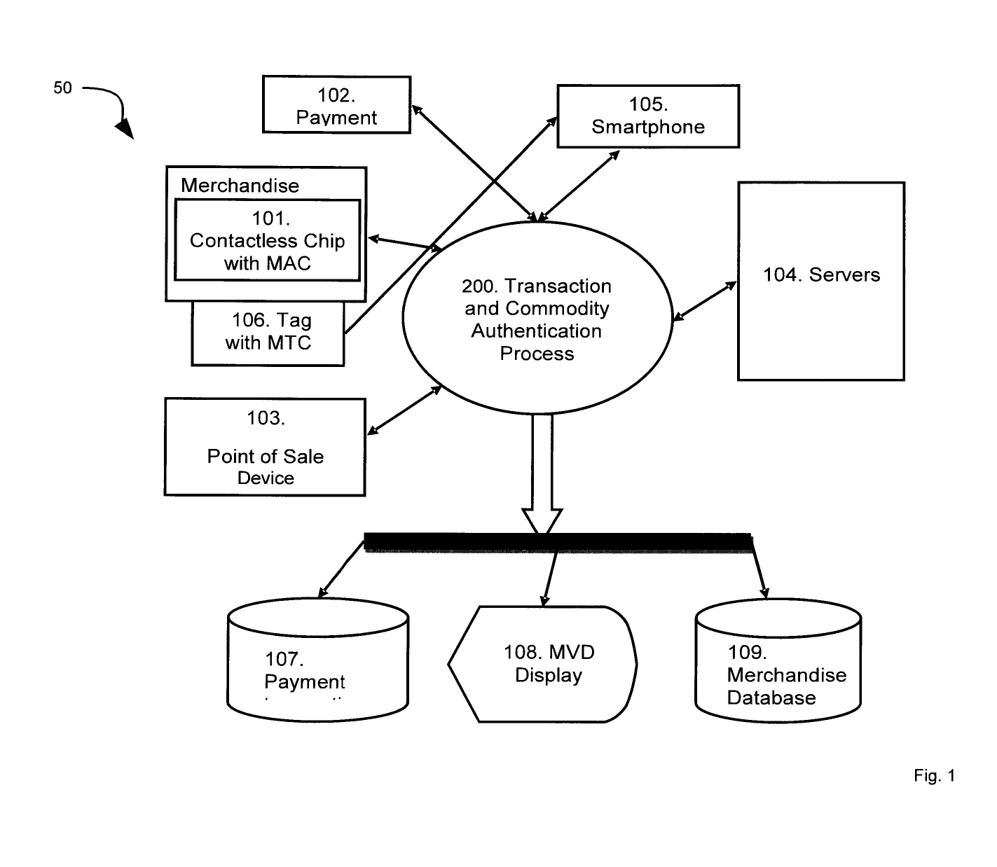

Referring now to FIG. 1, a brand name authentication and payment transaction system is indicated generally at 50 which can interact with a brand name authentication and payment transaction method 200. System 50 comprises the following components:

A Contactless Chip 101, which can be implemented as an unclonable (or difficult-to-clone) contactless Integrated Circuit Card or a microprocessor chip physically embedded into an item of merchandise or its packaging, carrying the Merchandise Authentication Code (MAC), uniquely identifying the item of merchandise, wherein “contactless” means having any contactless capability including but not limited to NFC, Bluetooth, infrared, or Radio-Frequency Identification (RFID).

A payment instrument 102, which can be implemented using any payment technology and related payment processes used to perform a payment transaction for the purchase of merchandise. For example: a payment card, an electronic purse or wallet device, whether privately issued or issued under the auspices of an issuer organization, a software payment application (e.g., PayWave™), or a payment card association (e.g. Visa®).

A Point of Sale (POS) device 103, which can be implemented as a device installed at the merchant's place of business where the merchandise is sold, having contactless capability, compatible with both the Contactless Chip and the Payment Instrument.

One or more service providers that hosts or operates at least one server 104, that is, the combined technology required to perform payment transaction processing and merchandise authentication processes comprising the payment system associated with the Payment Instrument and the merchandise lifecycle management system.

Server 104 can be configured to verify merchandise authenticity using (but not necessarily limited to) the following data elements:

an indicator that the merchandise was shipped to the store associated with the POS terminal 103 performing the payment transaction and merchandise authentication transaction;

lifecycle information related to the state of the merchandise in the sales process (e.g. sold, shipped, for sale);

data items associated with determination that the merchandise, Contactless Chip, or the Unique Tag has neither been revoked nor is it the subject of an active fraud investigation.

Server 104 can be implemented as a centralized system, or as a decentralized system, such as by cloud-based techniques. Other servers and computing elements discussed herein can be implemented likewise.

A smartphone 105 that can be implemented using any portable device acting as an appliance in a variety of form factors including but not limited to personal digital assistants and cellular phones, having Internet or similar network connectivity, messaging capabilities and are physically held or carried, wherein the smartphone phone number (or other smartphone identification data or unique identifier) associated with the payment instrument can be stored in the server 104 database.

A tag 106 (which is optional depending on the desired implementation), which can be implemented as a label, a certificate, affixed physically or logically, to the packaging of the item of merchandise or to the item itself. Tag 106 carries a Merchandise Tag Code (MTC), uniquely identifying the item of merchandise. The MTC can be an alphanumeric code or a barcode (or both). Smartphone 105 can be configured to scan or otherwise receive the MTC, such as by way of manual data entry including but not limited to keyboard entry or voice recognition methods. The MTC can be used for generating the proof of authenticity in the absence of contactless chip 101.

A general implementation of brand name authentication and payment transaction method 200 utilizes smartphone 105, POS terminal 103, and server 104 to communicate with each other and use information provided by (i) the contactless chip 101 or tag 106 and (ii) payment instrument 102, to perform the following actions, in any order, and can also, depending on the implementation of the method, perform the following actions in parallel:

Generate a payment transaction 107.

Authenticate the merchandise, and display 108 Merchandise Verification Data (MVD) on the display of smartphone 105.

Post the new lifecycle status of the merchandise and the transaction attributes in the server 104's merchandise lifecycle management database 109.

Authenticate the contactless chip 101 as a dialog between the contactless chip 101 and the smartphone 105 (optional step, not depicted).

Again, in certain implementations, the foregoing can be effected in such a way that the sale of an item of merchandise can only complete if and only if all the actions result in successful outcomes with respect to payment, item authentication and lifecycle database management and the end result of the authentication and authorization constituent processes is presented as a single outcome to the consumer.

The abovementioned MVD displayed on the smartphone 105 can include but is not limited to:

determination by server 104 regarding authenticity of the item of merchandise

the location of the store to which the merchandise was shipped;

the date when the item of merchandise was shipped to the store;

the date the item of merchandise was received by the store;

the serial number of the item of merchandise;

the colour, size, style, configuration, shape, and discrete components comprising a physical description of the item of merchandise.

Optionally, when smartphone 105 is not capable of communicating with the contactless chip 101, the MTC is either scanned or manually entered into an application present on the Smartphone. Optionally, some server 104 components can be implemented as hardware or software components of payment instrument 102, contactless chip 103, or smartphone 105. For example, contactless chip 103 can comprise the merchandise database, or the smartphone can comprise the payment authorization service.

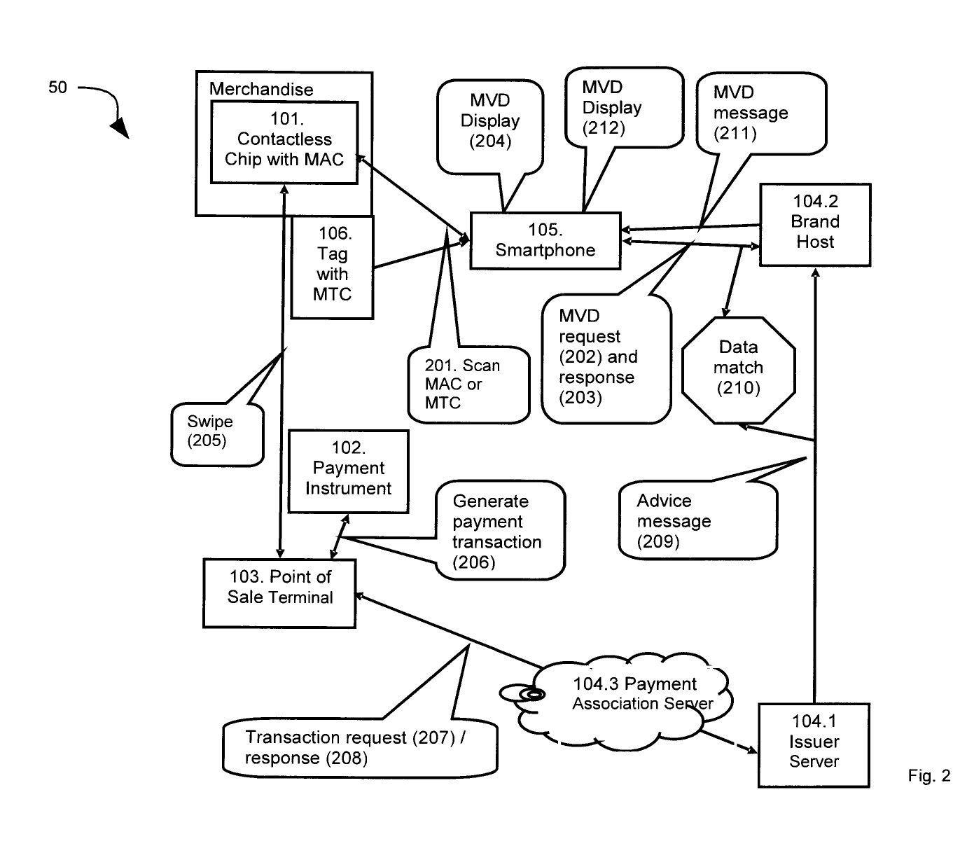

Referring now to FIG. 2, one example specific implementation of method 200 is indicated as method 200a in relation to the components of system 50.

Method 200a can be generally described as a brandname authentication embedded into a conventional payment card transaction.

Whereas the general method 200 implies any possible implementation of the payment process, the variant method 200a illustrates the specific embodiment of the general method 200 pertinent to the conventional (i.e. as implemented by Visa® or MasterCard®) processing of payment card transactions. In this method 200a, the server 104 comprises the following entities:

An issuer host server 104.1, which can be implemented as a computer system acting on behalf of the issuer of payment instrument 102.

A brand host server 104.2 which can be implemented as a computer system acting on behalf of the manufacturer or the brand, the brand name rights holder, or the rights holder's agent. Brand host server 104.2 has a database managing the merchandise lifecycle. As a variant, brand host server 104.2 can be a subsystem of the issuer host server 104.1 or a subsystem of a payment association server 104.3, discussed below.

At least one payment association server 104.3, such as Visa®, MasterCard®, a private payment network, etc. As a variant, the issuer host server 104.1 can be a subsystem of a payment association server 104.3 or act on behalf of a Payment Association.

Method 200a comprises:

Block 201, which comprises within a store or other physical premises scanning of the contactless chip 101 with smartphone 105. Optionally, smartphone 105 verifies the contactless chip 101 authenticity using public or private key cryptographic techniques to validate the digital certificate of chip 101. If the Smartphone is not capable of reading contactless chips 101 or the merchandise does not have a contactless chip 101, the tag 106 can be scanned or the MTC thereon manually keyed into smartphone 105.

Block 202 which comprises smartphone 105 sending an MVD request message via the Internet or another networking infrastructure to the Brand host server 104.2. The request message contains the MAC or MTC.

Block 203 comprises the Brand host server 104.2 responding to Smartphone 105 with the MVD. The MVD may also provide some additional supporting or custom information regarding the authenticity of the merchandise, such as store location, when shipped to the store, or the like.

Block 204 comprises displaying the contents of MVD message on the display of Smartphone 105.

(Note: Block 203 and block 204 can be optional when block 210, block 211 and block 212, as described below, are implemented.)

The message exchange between smartphone 105 and the brand host server 104.2 can optionally be enhanced by way of cryptography or other security methods to protect the messages from tampering. One possible implementation of such a security technique is the use of a Secured Socket Layer (SSL) channel with mutual certificate-based client/server authentications.

If block 203 and block 204 are implemented, the consumer reads the MVD displayed on smartphone 105, compares it to information at hand such as: the appearance of the merchandise, store identity and location, and makes a conditional affirmative decision about the purchase, and advises the salesperson in the store. The purchase decision remains conditional at this point because the final purchase decision will depend on the merchandise authenticity verification resulting from the process embedded in the purchase procedure described below.

Block 205 comprises presenting the merchandise (e.g. swiped past a detector within POS terminal 103) to the POS terminal 103 in such a way that the contactless chip 101 and the POS terminal 103 establish a secure communication session and the POS terminal 103 captures the MAC and possibly also verifies the Contactless Chip or MAC authenticity.

Block 206 comprises the POS terminal 103 and the payment instrument 102, generating a payment transaction.

Block 207 comprises POS terminal 103 sending a transaction request message to the issuer host server 104.1, possibly via a payment association server 104.3 (or payment association network) including the MAC in the message.

Block 208 comprises the Issuer host server 104.1 authorizing or declining the transaction and sends the response to the POS terminal 103.

Block 209 comprises issuer host server 104.1 advising brand host server 104.2 about the purchase including the MAC.

Optional block 210 comprises brand host server 104.2 matching the MAC obtained at block 202 with the MAC obtained at block 207 in order to ensure, or attempt to ensure, that the merchandise scanned by smartphone 105 is the same as the merchandise scanned by the POS terminal 103.

Block 211 comprises brand host server 104.2 returning the MVD to the smartphone 105 the difference between the MVD in this block 211 and block 203 and, that, at this point, optionally, the final purchase decision can be made by the consumer, and if the consumer does not accept the purchase, the servers will be notified, and the purchase transaction will be reversed (not depicted on the FIG. 2). Otherwise the merchandise will obtain a “sold” lifecycle status as the purchase has been completed.

Block 212 comprises displays the MVD on the display of smartphone 105.

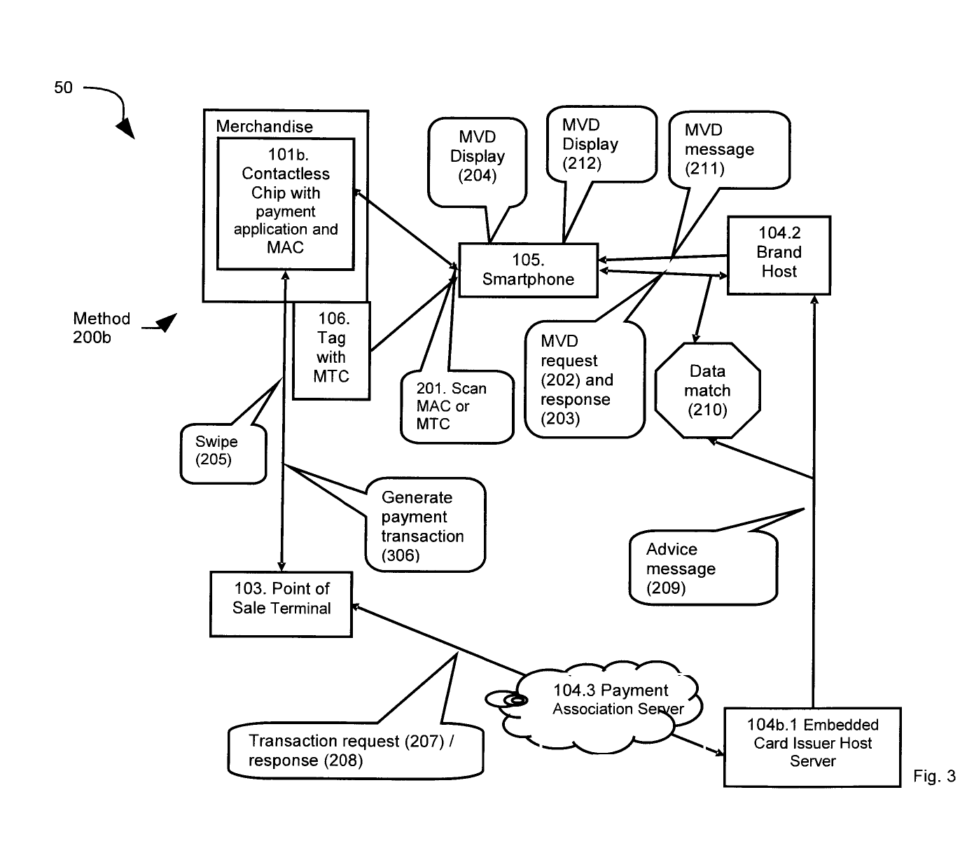

Referring now to FIG. 3, another example specific implementation of method 200 is indicated as method 200b in relation to the components of system 50.

Method 200b can be generally described as a brand name authentication embedded into an ICC payment card 101b which is used in place of contactless chip 101. More specifically, method 200b is a variant of method 200a, but which does not require:

technical modification of POS terminal 103 for capturing the MAC from the Contactless Chip;

modification of the conventional payment system associated with payment association server 104.3 for processing by including additional data, (i.e., MAC or MTC) into the Payment Association message structure.

In this variant, the embedded contactless chip 101 is replaced by an ICC payment card 101b. The issuer of this card is called hereafter “the Embedded Card Issuer”. The Embedded Card Issuer acts on behalf of the brand name owner.

This variant of method 200a is depicted in FIG. 3 as method 200b and described below:

Block 201, block 202, block 203 and block 204 remain substantially unchanged from the method 200a.

The ICC payment card 101a is embedded into the merchandise, and the POS terminal 103 is not modified to capture specific data from the contactless chip 101. Instead, in block 205, the POS terminal 103 captures the data from the embedded ICC payment card 101b as a part of a conventional contactless payment transaction. This data, which is typically a card number, is a functional equivalent to the MAC. The contactless payment card transaction 306 can thus be any transaction including but not limited to: (i) a purchase transaction charging a symbolic balance preloaded at the brand name-issued card, (ii) a card status check, (iii) a card activation transaction.

The above transaction becomes a transaction request 207 routed by the payment association server 104.3 (or its related network) embedded card issuer host server 104b.1 according to the protocols prescribed by the payment association network's defined standard.

Subsequent steps in method 200b differ only in that:

Issuer Host Server 104.1 is replaced by an embedded card issuer host server 104b-1. (To clarify, embedded card issuer host server 104b.1 is the issuer of ICC payment card 101b.)

Because ICC payment card 101b comprising the contactless chip is not ultimately being used as a payment instrument, a financial transaction to satisfy payment for the actual merchandise is still typically required, such as by cash, debit card, credit card, e-purse.

Method 200b can be desired when it is desired to make no changes to either merchant's POS terminal 103 or to the payment association server 104.3 or other payment association network interfaces.

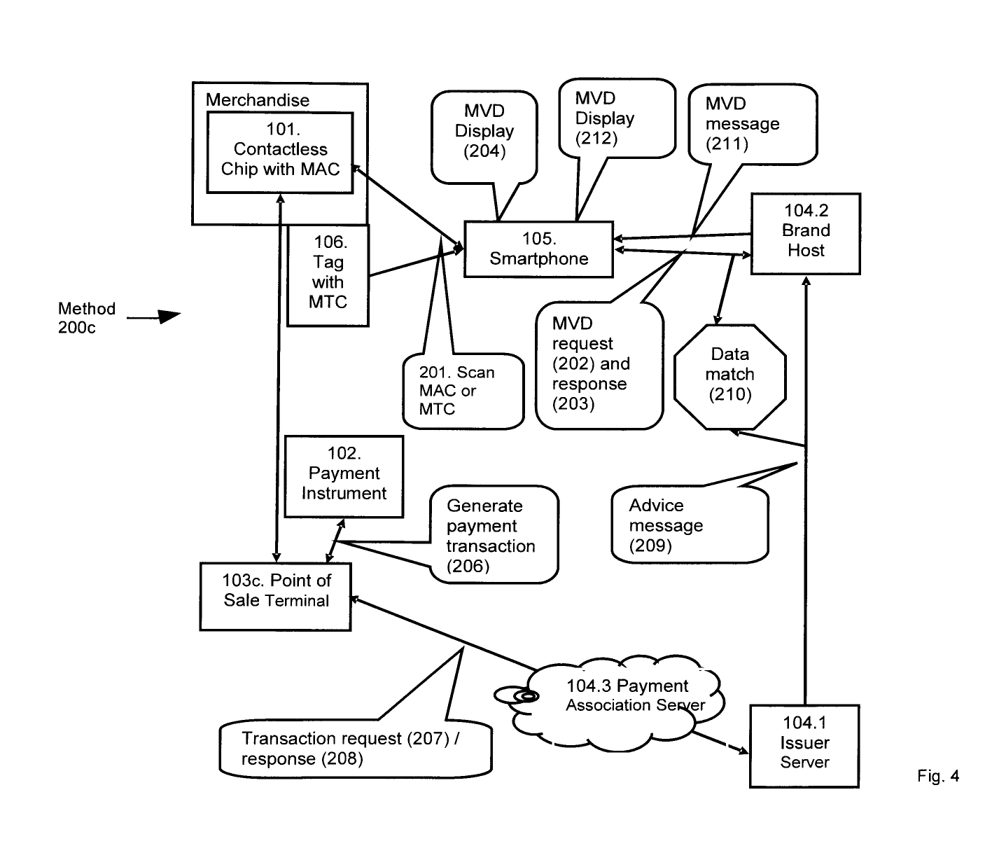

Referring now to FIG. 4, another example specific implementation of method 200 is indicated as method 200c in relation to the components of system 50.

Method 200c can be generally described as a brand name authentication method for point of sale terminals where a contactless chip is not embedded into the merchandise or the POS terminal 103c does not support interaction with contactless chips. If the contactless chip 101 is embedded in the merchandise but the POS terminal 103c is not contactless-capable, the MAC can be made available to the POS terminal 103 by smartphone 105 by way of the following:

The display of an image, icon, barcode or alphanumeric representation of the MAC that can be scanned by the POS terminal 103c or, in the case of alphanumeric representations, can be manually keyed into the POS terminal 103c.

Wireless transmission to POS terminal 103c by way of Bluetooth, TCP/IP or other communication technology.

If tag 106 is present, the MTC might be made available to the POS terminal 103c by smartphone 105 by means including but not limited to:

The display on smartphone 105 of an image, icon or barcode representation of the MTC that can be scanned by the POS terminal 103c.

Wireless transmission to the POS terminal 103c by way of Bluetooth, TCP/IP or other communication technology.

If tag 106 is present the MTC can be made available to the POS terminal 103c by the following:

The MTC can be manually keyed into the POS terminal 103c.

The MTC can be scanned off tag 106 into POS terminal 103c.

The description below relates to the certain differences from the method 200a as they relate to scanning of tag 106 by POS terminal 103, and relates to FIG. 4, though some of these variants of method are not expressly depicted in FIG. 4.

At block 201 or block 204, smartphone 105 displays the MAC that is captured at block 405.

At block 405, instead of swiping the embedded Contactless Chip 101, the MAC is keyed into the POS terminal 103 as a result of having been captured and displayed by smartphone 105. Alternatively, the MTC is scanned at point of sale terminal 103c as a barcode, etc. Alternatively, the MAC is displayed at smartphone 105 and scanned by the POS terminal 103c from the smartphone screen or captured from the smartphone 105 using contactless interfaces.

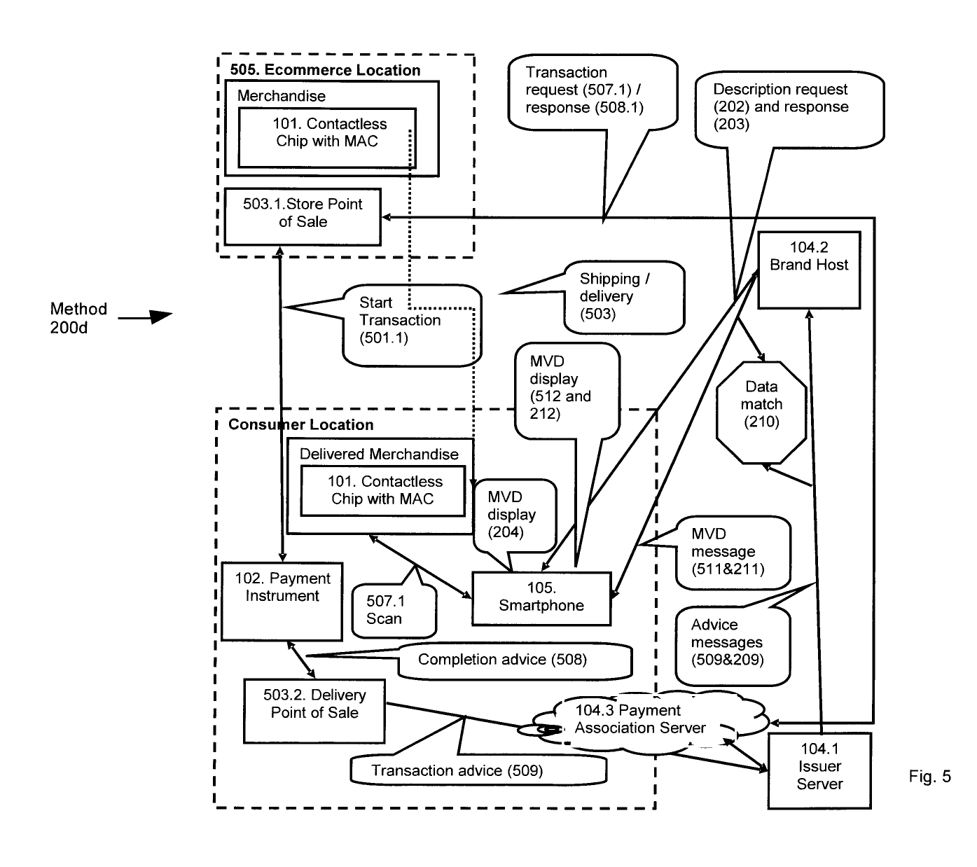

Referring now to FIG. 5, another example specific implementation of method 200 is indicated as method 200d in relation to the components of system 50.

Method 200d can be generally described as a brand name authentication method for e-commerce transactions. Method 200d caters to the situations where the merchandise is sold in a virtual environment such: as an e-commerce site on the Internet, a catalog or telephone order, then shipped and delivered to the consumer. The payment transaction and the merchandise identification process begin before the merchandise is shipped and completes when the merchandise is formally received by the consumer.

As shown in FIG. 5, this variant differs from the method 200a in the following ways:

POS terminal 103 is replaced by two parts, namely, a store POS equipment 503.1 that is implemented as an e-commerce server and a delivery POS equipment 503.2 equipment that is used by the individual responsible for physical delivery of the merchandise.

Blocks 201, block 202, block 203 and block 204 are eliminated and instead a check-out process takes place according to the following:

Block 501.1 comprises initiating a payment transaction remotely, possibly via Internet.

Block 507.1 comprises sending the payment transaction to the issuer host server 104.1, possibly via the payment association server 104.3 or its related network.

Block 508.1 comprises the issuer host server 104.1 responding to the Store POS terminal 503.1 by authorizing the payment transaction.

Block 509 comprises the Issuer host server 104.1 sending an advice message to the brand host server 104.2 regarding initiation of the transaction.

Block 511 comprises the brand host server 104.2 sending the MVD to the Smartphone and posts the merchandise in the lifecycle database as “shipped to the consumer”.

Block 512 comprises smartphone 105 displaying the MVD that is enhanced with information that advises the consumer about shipping details.

Block 503 comprises shipping and delivering the merchandise.

At the time of the merchandise delivery the following steps can take place:

Block 507 comprises the merchandise, still within the package of parcel, is presented (i.e. swiped past a detector) to the Delivery POS terminal 503.2 in such a way that the embedded Contactless Chip and the Delivery POS establish the communication session and the Delivery POS captures the MAC.

Block 508 comprises delivery POS terminal 503.2 and the payment instrument 102 generating a payment transaction completion advice.

Block 509 comprises delivery POS terminal 503.2 sending a transaction completion advice message to the issuer host server 104.1, possibly via the Payment Association server 104.3 network, including the MAC in the message. Block 509 comprises issuer server 104.1 advising brand host 104.2 about the transaction completion, including the MAC in the message. Block 511 comprises brand host sending the MVD message to smartphone 105. If the consumer is satisfied with MVD content, the transaction is completed. Otherwise it is reversed.

Block 208 of method 200a is not implemented, but the other steps remain substantially unchanged.

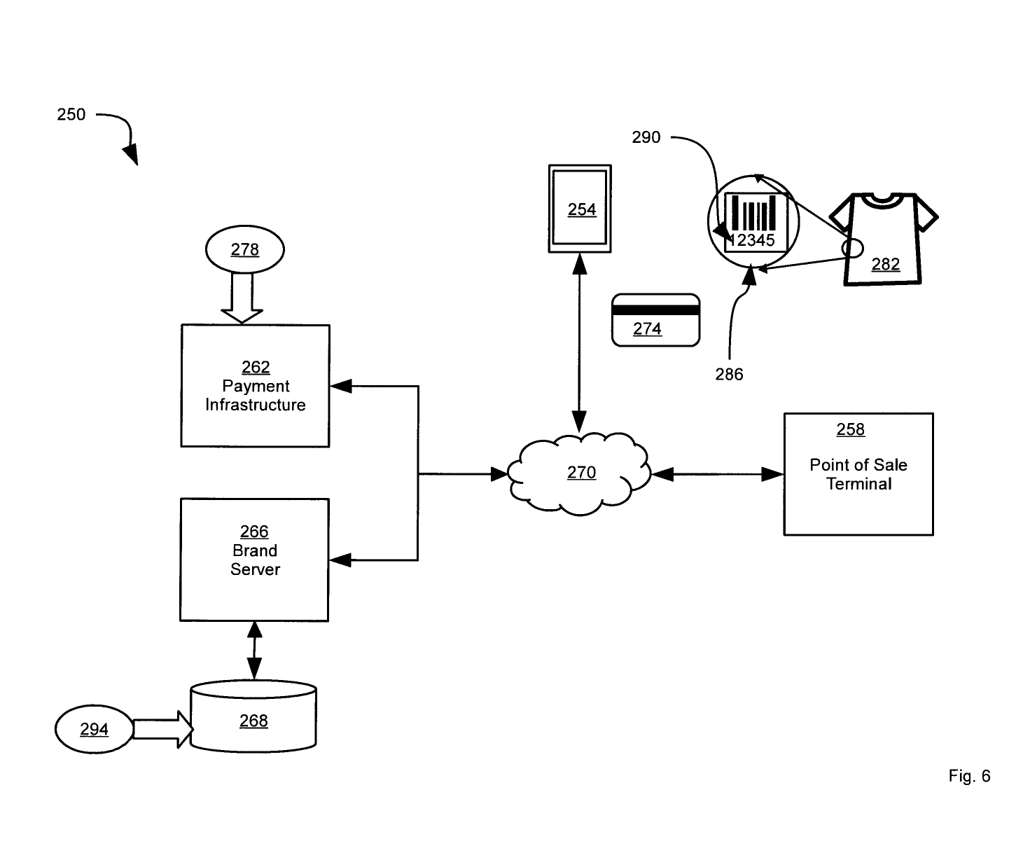

FIG. 6 is schematic representation of a brand name authentication and transaction system 250 in accordance with another embodiment. System 250 is a variation on system 50, as will be discussed further below.

System 250 comprises a first computing element in the form of a portable computing device 254 which can be implemented in a variety of ways, such as a smartphone, a cellular telephone, or variants thereon, as will be discussed further below. Expressed in other words, portable computing device 254 can be based on any suitable computing environment, and the type is not particularly limited. Portable computing device 254 is generally analogous to smartphone 105 from system 50 or variants thereon.

System 250 also comprises a second computing element in the form of a point of sale terminal 258 which can be implemented in a variety of ways, as will be discussed further below. Point of sale terminal 258 is generally analogous to point of sale terminal 103 from system 50 or variants thereon.

System 250 also comprises a payment infrastructure 262, which can be implemented in a variety of ways. For example, payment infrastructure 262 can be implemented using a combination of computing elements in the form of an issuer host server 104.1, payment association server 104.3, or variants thereon. However, as will be understood by further review of this specification, payment infrastructure 262 can, in general, be implemented using any known or future contemplated electronic payment transaction processing infrastructure.

System 250 also comprises another computing element in the form of brand server 266, which can be implemented in a variety of ways, as will be discussed further below. Brand server 266 is generally analogous to brand server 104.2 or variants thereon. Brand server 266 connects to an item database 268 (which is generally analogous to database 109) and which will be discussed further below.

A network 270 interconnects portable computing device 254, point of sale terminal 258, payment infrastructure 262 and brand server 266. Note that, as will be discussed further below, not all components in system 250 necessarily communicate with each other, and so network 270 can be implemented as a plurality of different networks or links as necessary to provide the various communication pathways contemplated herein.

Computing elements discussed herein can be based on any appropriate computing environment, including appropriate configurations of one or more central processing units (CPUs) configured to control and interact with memory (including volatile memory such as Random Access Memory (RAM), and non-volatile memory such as hard disk drives or FLASH drives, or a Redundant Array of Inexpensive Disks (RAID) or cloud-based storage, network interfaces to connect to network 270, all according to the specific design configurations of those computing elements. Indeed, cloud-based computing services, in addition to cloud-based storage, can also be used, including public, private or hybrid clouds. Such computing elements can also be configured to include input devices such as a keyboard or pointing device or output devices such as a monitor or any of or all of them, to permit local interaction.

Other more specific types of hardware configurations and computing components are contemplated according to the specific needs of a particular hardware component in system 250.

For example, brand server 266 can be implemented as part of a cloud-based computing solution, whereby the functionality of brand server 266 is implemented as one or more virtual machines executing at a single data center or in a mirrored form across a plurality of data centers. The software aspect of the computing environment of server 266 can also include remote access capabilities in lieu of, or in addition to, any local input devices or local output devices. Any desired or suitable operating systems can be used in the various computing environments. The computing environment can be accordingly configured with appropriate operating systems and applications to effect the functionality discussed herein.

More specifically, portable computing device 254 is typically based on a smaller, less powerful computing platform to accommodate the weight and power limitations of portable computers.

Point of sale terminal 258 is based on computing environment that is configured to finalize financial transactions whereby funds are exchanged for a particular good or service. (Other types of consideration, other than funds, are contemplated, including, without limitation, coupons, vouchers, and micro-currencies or digital currencies that are not backed by any national government that may only be intended for use within a small area. An example of a micro-currency is bitcoins.) The structure of such a computing environment again comprises an interconnection of processor(s), memory, along the lines of the general computing environments discussed above, however scaled in resources and software for point of sale purchases. The computing environment of each point of sale terminal 258 also typically includes one or more input devices in the form of one more of a keyboard, a pointing device and a proximity reader. Various types of proximity readers are contemplated including but not limited to bar code scanners, radio frequency identification (RFID) readers, smart card readers, and magnetic stripe readers. The foregoing generally contemplates a cash-register type staffed by a clerk, or an unstaffed stand-alone kiosk, the kind of point of sale terminal 258 found in retailers, service providers or other physical premises. Other types of point of sale paradigms are also contemplated within to be in the scope of point of sale terminals 258 however, including servers that are hosted by Internet retailers which process on-line ordering of goods which are scheduled for physical delivery, or services which may be rendered over the Internet (e.g. a media purchase or rental of music or film or book). It is generally contemplated that a plurality of point of sale terminals can be provided in variants of system 250, where each point of sale terminal 258 is configured differently, with different computing environments, so that the particular processing operations to effect a financial transaction are different. Point of sale terminal 258 is typically configured to connect to a traditional payment infrastructure 262 consisting of banks, credit card companies, and other financial institutions.

System 250 also comprises a payment instrument (generally analogous to payment instrument 102 of system 50) which in a present embodiment is implemented as a payment card 274 in a present embodiment. Payment card 274 can, in certain implementations, be a credit card or debit card associated with a financial account 278 that is maintained within, or in association with, payment infrastructure 262. Accordingly, payment card 274, point of sale terminal 258, payment infrastructure 262, and financial account 278 are, in a present implementation, structurally and functionally based on any standard payment system such as the Visa or MasterCard network, or in Canada the Interac™ debit network. A wide variety of other standard payment networks will now occur to those skilled in the art, and it is contemplated any such presently known, or future contemplated standard payment networks can be used in accordance with the present teachings. Payment card 274 can comprise one or more of magnetic stripe or a chip which stores an electronic representation of a unique account number associated with financial account 278. Credentials and other security features are typically incorporated into payment card 274 according to such standard payment system specifications.

In variations, payment card 274 can be directly incorporated as a near field communications (NFC) module, or other proximity communication technologies, directly into portable computing device 254. This variation can be particularly germane where payment infrastructure 262 is actually implemented by service provider that carries network traffic for computing device 254, or a manufacturer of computing device 254. Accordingly, the skilled reader will now recognize that another contemplated payment infrastructures 262 includes PayPal™. Another contemplated payment infrastructure 262 includes a billing system maintained by a service provider that carries network traffic for computing device 254. Another contemplated payment infrastructure 262 thus includes a payment infrastructure 262 maintained by a manufacturer or developer of computing device 254, such as a payment system that is through the Apple “App Store” or the like that is currently available on iPhones and iPads from Apple Inc. According to this example and similar examples, the functionality of point of sale terminal 258 can also integrated into computing device 254.

Other types of payment instruments (and complementary payment infrastructures 262) that can be used in lieu of payment card 274 are thus contemplated and will now occur to those skilled in the art.

As will be discussed further below, an association between portable computing device 254 and payment card 274, or between portable computing device 254 and financial account 278 can be maintained on a database within system 250, such as database 268.

While not shown in system 250, it is contemplated that system 250 can be scaled to thus accommodate a plurality of different standard payment infrastructure 262 and their corresponding payment instruments and different types of those payment instruments.

System 250 also comprises an item 282, which generally analogous to merchandise 101. Item 282 itself comprises an item identification instrument 286, which is generally analogous to, and can be implemented using contactless chip 101 or tag 106 or a variation thereon. Item identification instrument 286 thus comprises unique item identifier 290 which is generally analogous to Merchandise Authentication Code (MAC) or Merchandise Tag Code (MTC) or a variation thereon. In general, item identifier 290 is any alphanumeric string or other indicia that uniquely identifies item 282 from other items. Item 282 is drawn in FIG. 1 as a shirt to illustrate that the present specification can have particular application in the field of authentication of clothing merchandise as being original and not counterfeit. However, the present specification is not limited to shirts, clothing, or any particular types of merchandise and can be applied to any items, products, merchandise for which unique identification is desired or required. Thus item identification instrument 286 is any type of medium that can store item identifier 290, and can comprise contactless chips, near field communication chips, radio frequency identification tags, or can comprise tags with optical information such as alphanumeric strings or optically readable indicia such as bar codes or quick response (QR) code. A plurality of different item identification instruments 286 can also be provided on item 282, provided that each item identification instruments 286 ultimately stores, or at least associated with, the same unique item identifier 290.

In a general sense, it is to be understood that instrument 286 is structured to be readable by the available input devices on portable computing device 254 and point of sale terminal 258.

Item identifier 290 in turn is also a unique index associated with an item identification record 294 that is stored on database 268. Item identification record 294 can be implemented in substantially the same manner as merchandise verification data (MVD) discussed above. However, in one basic implementation, item identification record 294 at least maintains item identifier 290 and some associated data that verifies authenticity of the item, such that a query of database 268 by device 254, or other network connected device, about item 282 returns an indication or some other validation that item 282 is authentic, or expressed differently, confirms that item 282 is not counterfeit. It is to be understood that as system 200 is scaled, a plurality of different items 282, of different types and brands can be accommodated, with each item 282 having its own unique item identifier 294 and its own item identification record 294. Table I shows a more complex, yet purely exemplary, implementation of a record structure item identification record 294.

TABLE I
Example structure of item identification record 294

| Field Number | Field Name | Example Contents | Content Description |
|---|---|---|---|
| 1 | Item identifier 290 | 12345 | Unique index/identifier |
| | | | that uniquely |
| | | | distinguishes item 282 |
| | | | from all other items. |
| 2 | Current legal owner | ABC Retailers | Identification of legal |
| | | | entity that currently has |
| | | | legal ownership. For |
| | | | purpose of example |
| | | | discussion, it will be |
| | | | assumed that POS |
| | | | terminal 258 is also |
| | | | owned and operated by |
| | | | ABC Retailers. |
| 3 | Current location | ABC Retailers, 123 Smith | Identification of a |
| | | Street, Jonesville, | physical address where |
| | | Somestate, Somecountry | item 282 is expected to |
| | | | be located. |
| 4 | Current date of | Jan. 1, 2012 | The date when the |
| | acquisition | | current legal owner took |
| | | | legal ownership. |
| 5 | Previous legal | None | Identification of legal |
| | owner | | entity that previously has |
| | | | legal ownership |
| 6 | Previous date of | None | The date when the |
| | acquisition | | previous legal owner |
| | | | took legal ownership. |
| 7 | Item Description | White T-shirt, X-Large, | Any data that describes |
| | | Cotton | item 282 in terms of its |
| | | | characteristics. For |
| | | | example, this can be |
| | | | based on a catalogue |
| | | | description. |
| 8 | Brand | BCD Clothing | The trademark or brand |
| | | | associated with item 282 |
| 9 | Manufacturer | BCD Clothing Corporation | The legal entity that |
| | | | manufactured item 282. |

Additional, or fewer fields can be provided in Table I.

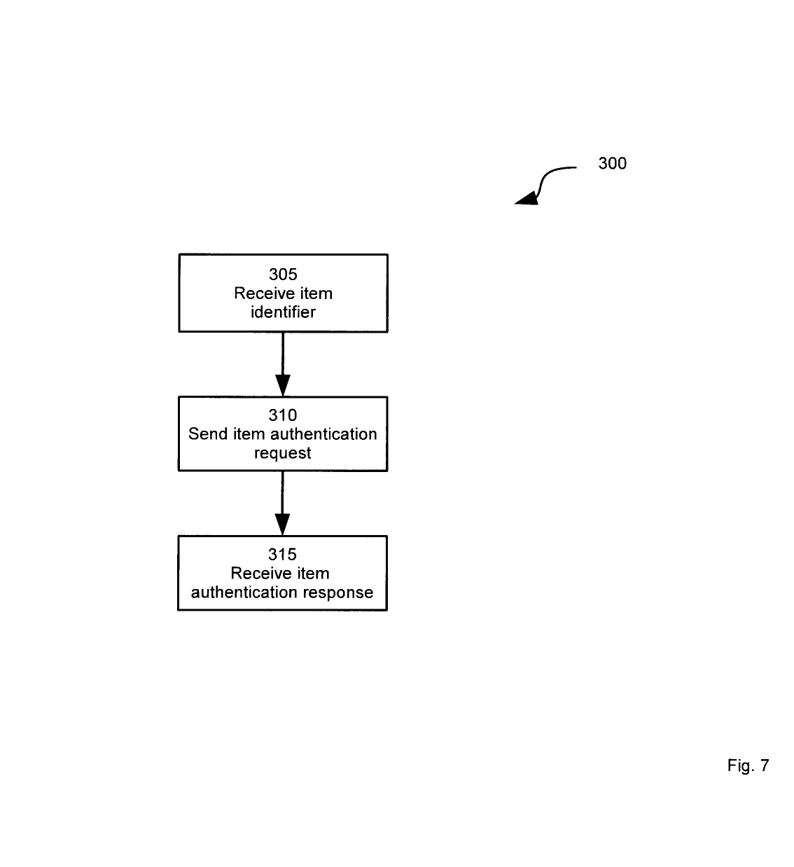

Referring now to FIG. 7, a flowchart depicting a method for brand name authentication is indicated generally at 300. Method 300 is one way in which device 254 can be configured. It is to be emphasized, however, that method 300 need not be performed in the exact sequence as shown; and likewise various blocks may be performed in parallel rather than in sequence; hence the elements of method 300 are referred to herein as “blocks” rather than “steps”. It is also to be understood, however, that method 300 can be implemented on variations of device 254 as well.

Block 305 comprises receiving an item identifier. Generally, block 305 contemplates receiving, item identifier 290 via an input device in device 254. The exact mechanism can vary depending on the types of input devices available on device 254, and the way in which item identification instrument 286 is implemented. For example, if item identification instrument 286 is a contactless chip, and device 254 has a contactless chip reader, then item identification instrument 286 can be swiped, or place in proximity to the contactless chip reader in device 254, thereby transferring item identifier 290 into device 254. As another example, if item identification instrument 286 is an optical code (e.g. a bar code or a QR code), and device 254 has a camera or other optical input device, then the optical code can be placed within an optical path of the optical input device of device 254, thereby transferring item identifier 290 into device 254. As another example, if item identification instrument 286 comprises a printed text string showing item identifier 290, and device 254 has a keyboard input device, then the printed text string can be typed into the keyboard of device 254, thereby transferring item identifier 290 into device 254. It should be understood that, in some configurations of device 254 and item identification instrument 286, a plurality of such options may be possible.

Block 310 comprises sending an item authentication request. Generally, block 310 contemplates sending the item identifier received at block 205 to a computing system that is tasked with verifying the authenticity of the item to which the item identifier is attached. In system 250, it is contemplated that item identifier 290 is sent to brand server 266 via network 270.

Block 315 comprises receiving an item authorization response to the request from block 310. Generally block 315 contemplates that the computing system which received the request from block 310 will perform some computational operation that can be used to verify the authenticity of the item 282 to which the item identification instrument 286 is attached. In system 250, it is contemplated that brand server 266 performs such a verification computational operation, by retrieving record 294 using item identifier 290 to locate record 294, which then sends record 294 back to device 254. At this point, the contents of record 294 can be displayed on the display of device 254. The data within record 294, now locally displayed on device 254, can be used to provide a number of manual verification checks that the contents of record 294 are consistent with the current physical parameters (e.g. condition, description, location, current ownership) of item 282. (Note that in variations, the data within record 294 can be generated on another type of output device on device 254, other than a display, such as an audio message through a speaker on device 254.)

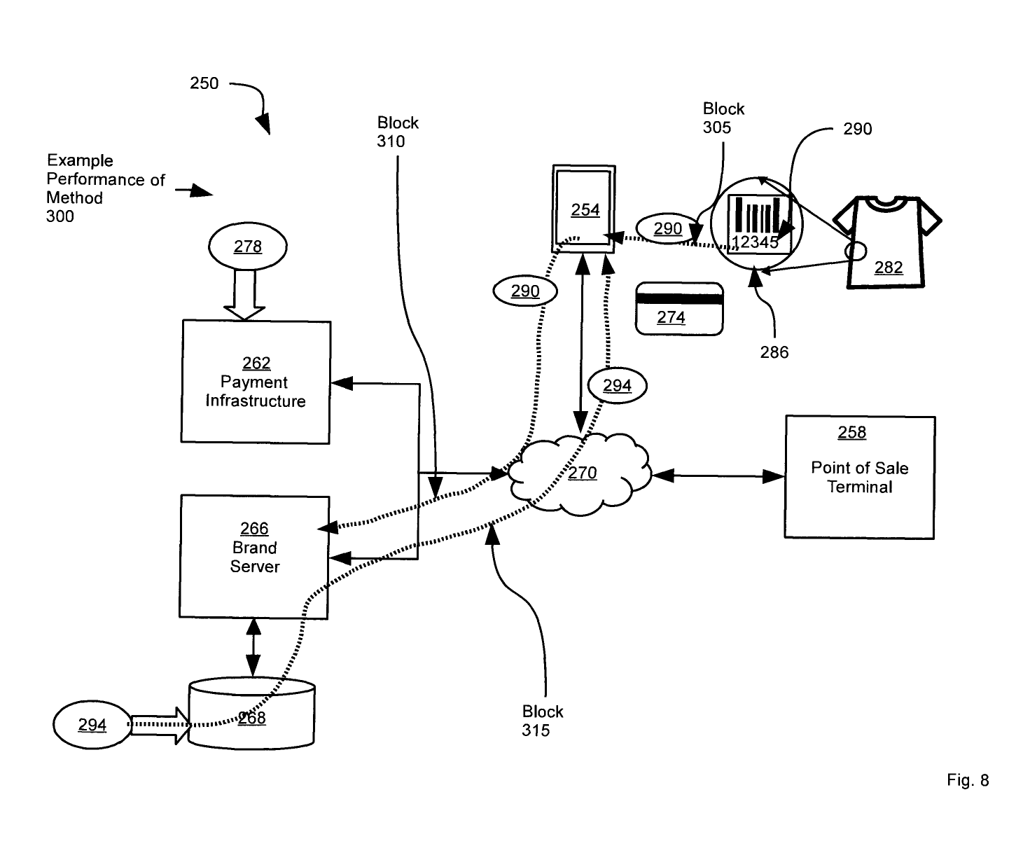

The foregoing specific, example performance of method 300 is shown in FIG. 8.

In a variation, block 310 and block 315 could be performed locally by device 254 and instrument 286 using known cryptographic and authentication methods. In this variation, the contents of fields 1, 7 and 8 from Table I of record 294 can be securely stored within instrument 286. The variation may be combined with the example in FIG. 8, in the event that, for example network connectivity between device 254 and brand server 266 is unavailable. Other variations of method 300 will now occur to those skilled in the art.

It will now be understood that, in accordance with method 300, an application is locally stored on device 254 that can implement method 300.

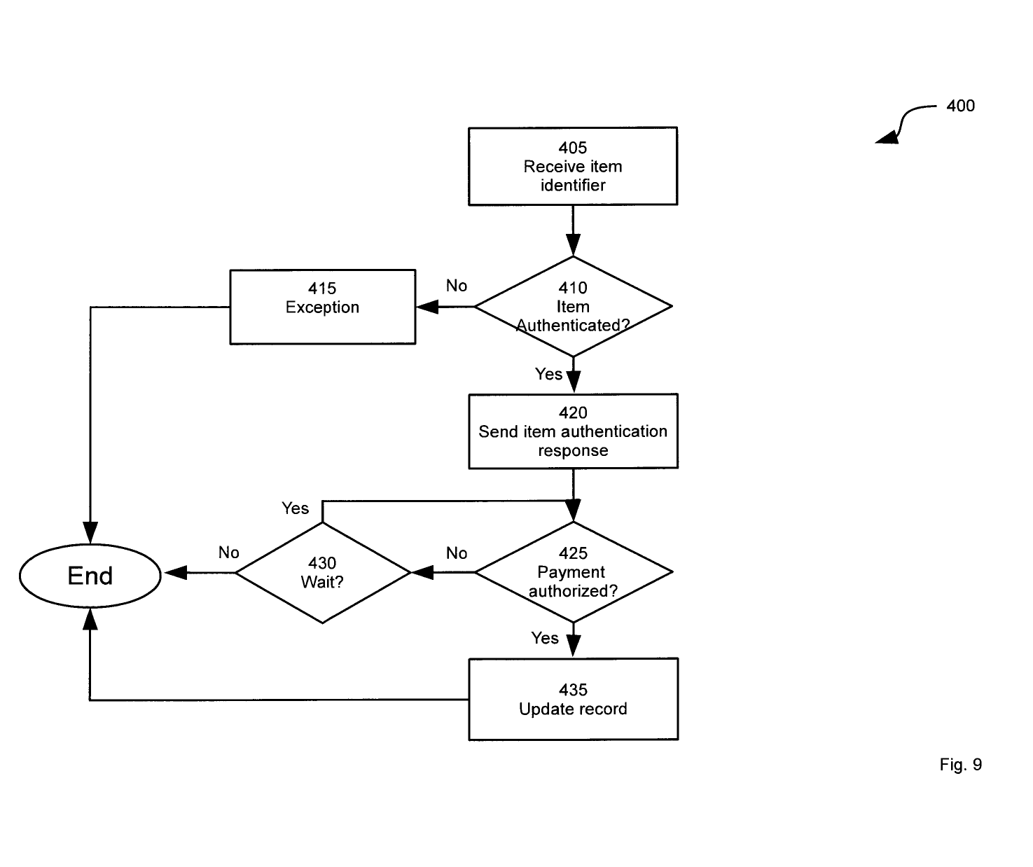

Referring now to FIG. 9, a flowchart depicting another method for brand name authentication is indicated generally at 400. Method 400 is one way in which brand server 266 can be configured. It is to be emphasized, however, that method 400 need not be performed in the exact sequence as shown; and likewise various blocks may be performed in parallel rather than in sequence; hence the elements of method 400 are referred to herein as “blocks” rather than “steps”. It is also to be understood, however, that method 300 can be implemented on variations of brand server 266 as well.

Before beginning discussing method 400 in detail, in general terms, block 405, block 410 and block 420 reflect the actions of server 266 in response to the performance of counterpart blocks in method 300.

Block 405 comprises receiving an item identifier. In the example of system 250, block 405 can be implemented by brand server 266 receiving item identifier 290, as the server-counterpart to the example performance of block 310 shown in FIG. 8.

Block 410 comprises performing an item authentication operation. Block 410 is optional, but generally contemplates determining if, based on the data received at block 405, and the contents of database 268, if item 282 associated with the item identifier 290 is authenticated. The criteria for determining authentication are not particularly limited. As a simple example, Table I in association with record 294 can be expanded to include a flag to indicate whether item 282 has been stolen. Thus, if such a flag indicates that item 282 is stolen goods, then a “no” determination is made leading to exception handling at block 415. In the case of stolen goods, the exception handling can include a notification to police. Another item authentication operation can include a location validation, whereby a location of device 254 is sent in conjunction with item identifier 290 and received at block 405. If the location of device 254 does not match an expected location (E.g. See Field 3 of Table I), then a “no” determination can be made again leading to exception handling at block 415.

Assuming a “yes” determination is made at block 410, then block 420 comprises sending an item authentication response back to the originating device that sent the item identifier received at block 405. In the example of system 250, block 420 can be implemented by brand server 266 sending record 294, as the server-counterpart to the example performance of block 315 shown in FIG. 8.

Block 425 comprises determining if payment for the item associated with the item identifier from block 405 has been authorized or otherwise effected. If “no”, then in certain implementations a wait state can be implemented at block 430. If the “wait” state is to continue, then method 400 cycles back to block 425 to continue to wait for authorization of payment. If the “wait” state is not to continue, then a “no” determination is made at block 430 leading back to the end of method 400.

If, however, at block 425 payment is authorized for the item associated with the item identifier from block 405, then a “yes” determination is made at block 425. At block 435, the record associated with the item identifier is updated to reflect the payment and other changes in status.

To provide further context, it is generally contemplated that method 300 and method 400 would be performed in during a retail shopping visit to a retail outlet associated with point of sale terminal 258 where item 282 is being offered for sale, and device 254 is being carried by a potential purchaser. The potential purchaser can utilize device 254 to verify the brand authenticity of item 282, using method 300, and then proceed to point of sale terminal 258 to complete a financial transaction, using payment card 274 to finalize the purchase. Accordingly, while block 405, block 410 and block 420 generally correspond to the brand authentication of method 300, block 425, block 430 and block 435 correspond to the purchase phase that is expected to occur, at least some of the time, subsequent to performance of method 300. Accordingly, block 425 contemplates that a “yes” determination will be made when a payment card 274 is used at point of sale terminal 258 and, in certain implementations, account 278 is accordingly debited to reflect the purchase price of item 282. The means by which confirmation of such payment is actually received at billing server 266 is not particularly limited, but non-limiting examples of such will be discussed in greater detail below in relation to method 500 and method 600. In the event no such purchase is made, perhaps within predetermined time period, then method 400 will end by passing through a “no” determination at block 425 and a “no” determination at block 430. In the event a purchase is made, then at block 435, record 294 is updated to record the particulars of the purchase.

(It is to be understood that a “yes” determination can be made at block 425 in other ways. For example, no actual debiting of account 278 need actually occur, but instead the contemplated financial transaction is authorized in relation to, for example, account 278 but without actually debiting account 278, thereby also leading to a “yes” determination at block 235. In this variation, the wait state at block 430 can be obviated as the authorization is sufficient to proceed to block 435, while the lack of authorization is sufficient to indicate that method 400 should end. Another example of implementation of block 425 is requesting of “yes” determination from account 278 implemented as an electronic purse or electronic wallet residing on the card 274.)

In general, it can be noted that method 400 can be modified according to the specific type of payment instrument and payment infrastructure that is used.

Table II shows an example update to Table I at block 435 in the event that item 282 is ultimately authorized at block 410 and block 425.

TABLE II
Example update to item identification record 294 after purchase of item 282

| Field | | | Content | Updated |
|---|---|---|---|---|
| Number | Field Name | Example Contents | Description | from Table I |
| 1 | Item identifier | 12345 | Unique index/ | No |
| | 290 | | identifier that | |
| | | | uniquely | |
| | | | distinguishes item | |
| | | | 282 from all other | |
| | | | items. | |
| 2 | Current legal | Sally Jones | Identification of legal | Yes |
| | owner | | entity that currently | |
| | | | has legal ownership. | |
| | | | For purpose of | |
| | | | example discussion, | |
| | | | it will is assumed | |
| | | | that the owner of | |
| | | | device 254, account | |
| | | | 278, and payment | |
| | | | card 274 is named | |
| | | | “Sally Jones” and | |
| | | | that she has | |
| | | | purchased item 282. | |
| | | | (Note this field may | |
| | | | be subject to privacy | |
| | | | restrictions and not | |
| | | | implemented in all | |
| | | | cases.) | |
| 3 | Current location | Sally Jones, 123 | Identification of an | Yes |
| | | David Street, | address associated | |
| | | Jonesville, | with Sally Jones, the | |
| | | Somestate, | current legal owner. | |
| | | Somecountry | (Note this field may | |
| | | | be subject to privacy | |
| | | | restrictions and not | |
| | | | implemented in all | |
| | | | cases.) | |
| 4 | Current date of | Jan. 10, 2012 | The date when the | Yes |
| | acquisition | | current legal owner | |
| | | | took legal | |
| | | | ownership. More | |
| | | | specifically, the date | |
| | | | when Sally Jones | |
| | | | used point of sale | |
| | | | terminal 258 to | |
| | | | purchase item 282. | |
| 5 | Previous legal | ABC Retailers | Identification of legal | Yes |
| | owner | | entity that previously | |
| | | | has legal ownership. | |
| | | | This is the former | |
| | | | contents of Field 2 in | |
| | | | Table I | |
| 6 | Previous date of | Jan. 1, 2012 | The date when the | Yes |
| | acquisition | | previous legal owner | |
| | | | took legal | |
| | | | ownership. This is | |
| | | | the former contents | |
| | | | of Field 4 in Table I | |
| 7 | Item Description | White T-shirt, X- | Any data that | No |
| | | Large, Cotton | describes item 282 | |
| | | | in terms of its | |
| | | | characteristics. For | |
| | | | example, this can be | |
| | | | based on a | |
| | | | catalogue | |
| | | | description. | |
| 8 | Brand | BCD Clothing | The trademark or | No |
| | | | brand associated | |
| | | | with item 282 | |
| 9 | Manufacturer | BCD Clothing | The legal entity that | No |
| | | Corporation | manufactured item | |
| | | | 282. | |

From Table II, now stored as record 294, it can be seen that the identity of the current owner has been updated to reflect the identity of the owner of payment instrument 274. Now, when method 300 is performed, either using device 254 or another device, the contents of Table II can be shown on the display of such a device 254.

It can be noted that block 420, block 425, and block 435 can be part of a stand-alone method, independent from the performance of block 405, block 410 and block 420.

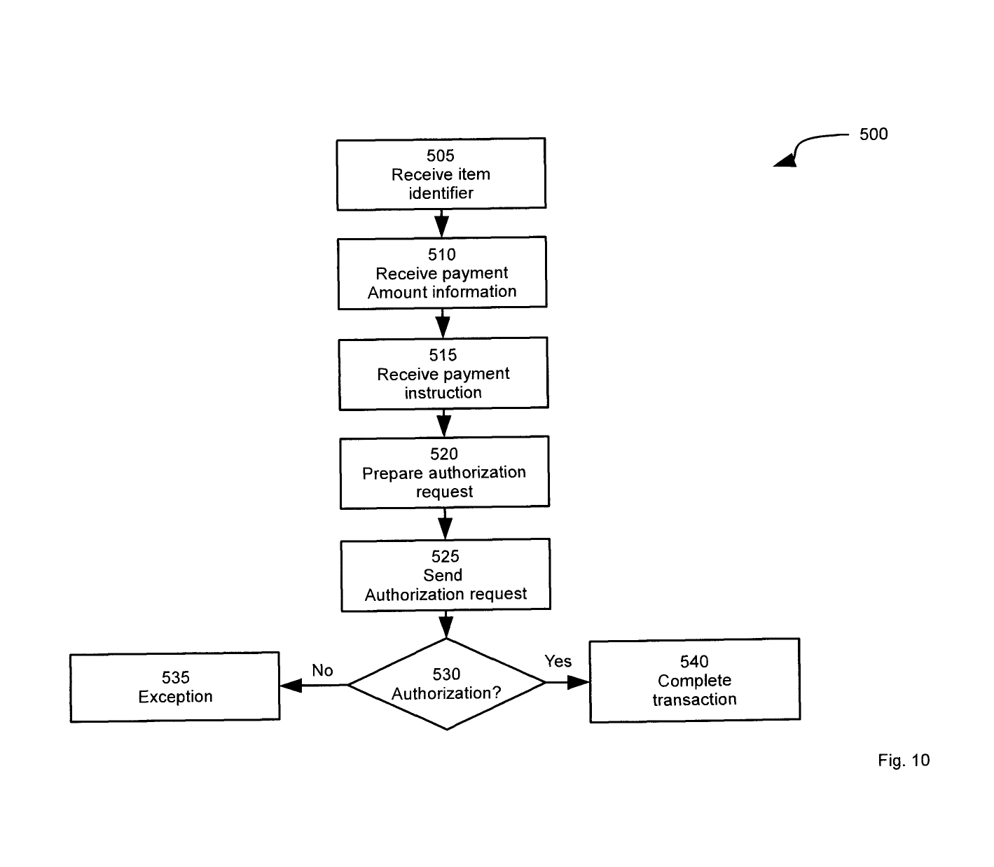

Referring now to FIG. 10, a flowchart depicting another method for brand name authentication is indicated generally at 500. Method 500 is one way in which point of sale terminal 258 can be configured. It is to be emphasized, however, that method 500 need not be performed in the exact sequence as shown; and likewise various blocks may be performed in parallel rather than in sequence; hence the elements of method 500 are referred to herein as “blocks” rather than “steps”. It is also to be understood, however, that method 500 can be implemented on variations of point of sale terminal 258 as well. Method 500 can also be one way in which payment information is prepared as part of the resulting corresponding performance of block 420, block 425 and block 435.

Block 505 comprises receiving an item identifier. Block 505 is substantially analogous to block 305, except that the item identifier is received at point of sale terminal 258 rather than at device 254. Again, generally, block 505 contemplates receiving, item identifier 290 via an input device in point of sale terminal 258. The exact mechanism can vary depending on the types of input devices available on point of sale terminal 258, and the way in which item identification instrument 286 is implemented. For example, if item identification instrument 286 is a contactless chip, and device 254 has a contactless chip reader, then item identification instrument 286 can be swiped, or place in proximity to the contactless chip reader in point of sale terminal 258, thereby transferring item identifier 290 into point of sale terminal 258. As another example, if item identification instrument 286 is an optical code (e.g. a bar code or a QR code), and point of sale terminal 258 has a camera or bar code scanner or other optical input device, then the optical code can be placed within an optical path of the optical input device of point of sale terminal 258, thereby transferring item identifier 290 into point of sale terminal 258. As another example, if item identification instrument 286 comprises a printed text string showing item identifier 290, and point of sale terminal 258 has a keyboard input device, then the printed text string can be typed into the keyboard of point of sale terminal 258, thereby transferring item identifier 290 into point of sale terminal 258. It should be understood that, in some configurations of point of sale terminal 258 and item identification instrument 286, a plurality of such options may be possible.

Block 510 comprises receiving payment amount information. In general block 510 contemplates receiving the purchase price for item 282 and any other information or calculations (e.g. taxes, rebates, coupons) that is necessary to establish a total sum that is required in payment for item 282 in order to transfer legal title to item 282 to the purchaser of item 282. Block 510 can thus be effected according to the technology used to implement point of sale 258, and can comprise, for example, manually keying in such information.

Block 515 comprises receiving a payment instruction. In system 250, block 515 contemplates that information related to account 278 from payment card 274 is received at point of sale terminal 258. Block 515 can be performed using any known, existing or future contemplated payment technologies according to standards set for payment card 274 and payment infrastructure 262 and point of sale terminal 258. In general it is contemplated that block 515 is performed according to a known pre-defined industry standard that is not modified according to this embodiment.

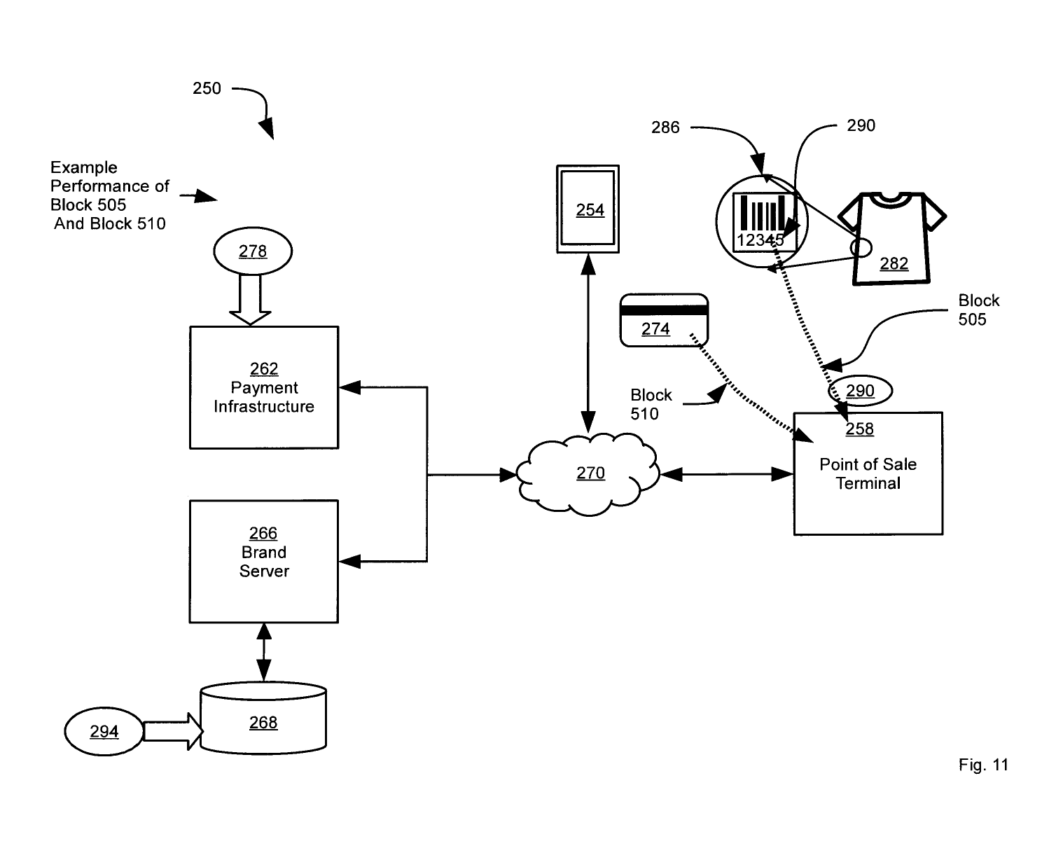

Example performance of block 505 and block 510 is represented in FIG. 11.

Referring back to FIG. 10, block 520 comprises preparing an authorization request. Block 520 comprises assembling the item identifier from block 505, payment information from block 510 and the payment instruction from block 515 into a data stream that, at block 525, will be sent over network 270.

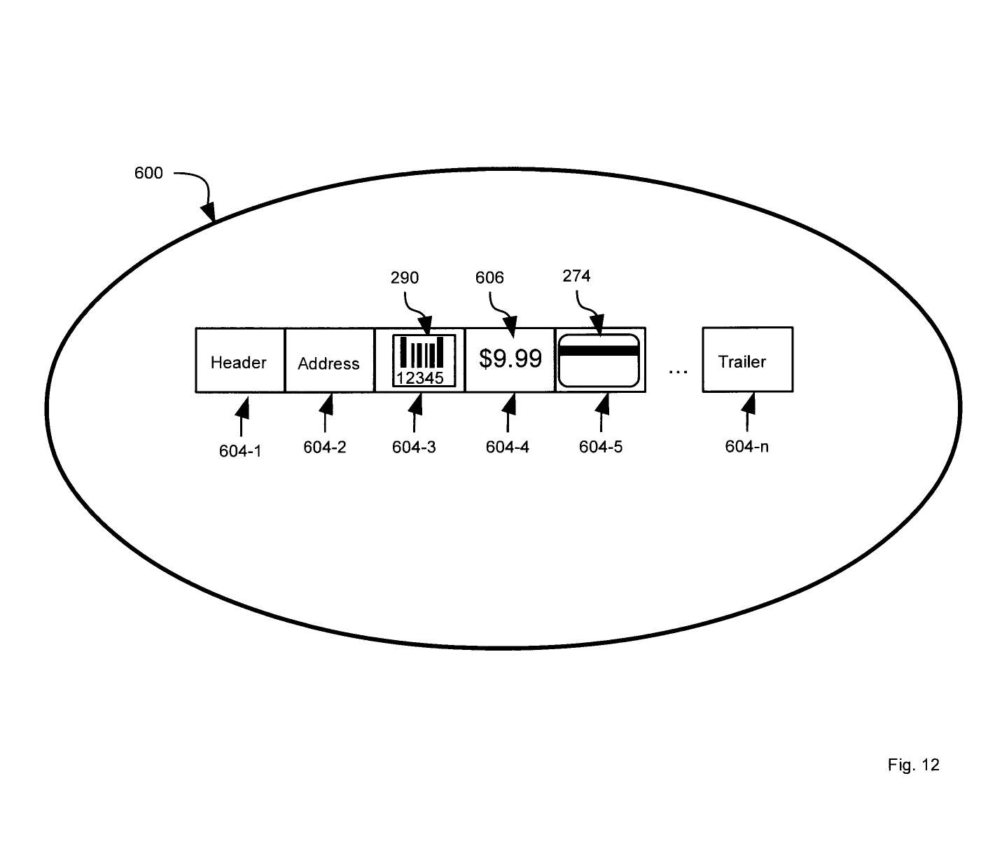

To help assist with a presently contemplated implementation of block 520, FIG. 12 shows an illustrative example data stream 600 that can be prepared at block 520. Data stream 600 comprises a plurality of fields 604-1, 604-2, 604-3 . . . 604-n. (Collectively, fields 604 and generically, field 604). In actual implementation, data stream 600 can be based on any known or future contemplated data stream formats that are prescribed according to industry standards prescribed by relevant payment infrastructure authorities. One non-limiting example of such an industry standard for formatting data stream 600 is ISO 8583, a standard promulgated by the International Organization for Standardization (ISO) which specifies financial transaction card originated messages/Interchange message specification, where the term “message” is the equivalent to the term data stream herein. Another example of such an industry standard is the Interactive Financial eXchange (IFX) Standard, an open, extensible (i.e. can be adapted to accommodate the inclusion of brand authentication processes in payment transactions), interoperable standard for financial data exchange that is designed to meet the business requirements of the global financial services industry. Another example is the ISO 20022—Universal financial industry message scheme, which is the international standard that defines the International Standards Organization platform for the development of financial message standards. ISO 20022 arose in the early 2000's with the widespread growth of Internet Protocol (IP) networking and the emergence of XML (eXtensible Mark-up Language), as the ‘de facto’ open technical standard for electronic communications and the appearance of a multitude of uncoordinated XML-based standardization initiatives, each having used their own “XML dialect”. On top of offering a common way of using XML, the new standard shields investments from future syntax changes by proposing a common business modeling methodology (using UML—Universal Modeling Language) to capture, analyze and syntax-independently describe the business processes of potential users and their information needs.

It therefore is to be emphasized that data stream 600 in FIG. 12 is an illustrative example. The actual fields shown, their order and contents is not particularly limited to the example shown in FIG. 12. Fewer or additional fields may be provided. The example in FIG. 12 is not shown in relation to any specific known standard, but rather intended to be illustrative so that the skilled reader will understand how to populate a data stream according to the desired standard in accordance with the teachings herein.

Field 604-1 is a header field that can be populated at block 520 according to any standard header field information that would typically be included in a data stream 600 that is implemented according to the relevant standard, which indicates the beginning of data stream 600.

Field 604-2 is an address field that specifies a network address to send data stream 600 that is implemented according to the relevant standard. The destination network address is assigned to a computing device that fulfills the transaction request represented by data stream 600.

Field 604-3 is a private data field as defined by the relevant standard, which is reserved to contain any desired data but not otherwise used for electronic payment processing according to the standard. In the present implementation, at least one private data field that is prescribed according to the relevant standard is populated with item identifier 290, and thus in the present example, field 604-3 is populated with item identifier 290. Thus, field 605-3 is populated with the item identifier received at block 505.

Field 604-4 is a payment information field as defined by the relevant standard, which is reserved to contain the payment amount in the electronic payment processing according to the relevant standard. Thus, field 604-4 is populated with a payment amount 606 of $9.99, payment amount 606 being received at block 510.

Field 604-5 is a payment instrument field defined according to the relevant standard that is contains payment instructions, including account 278 and other relevant information from payment card 274 that is needed to debit account 278 with the payment amount. Thus, field 604-6 is populated according to the payment instruction received at block 515.

Field 604-n is a trailer field that can be populated at block 520 according to any standard trailer field information that would typically be included in a data stream 600 that is implemented according to the relevant standard, which indicates the end of data stream 600.

In general, it can be noted that data stream 600 comprises a plurality of standard defined fields including at least one data field that can be used for storing item identifier 290. In a present implementation, it is contemplated that a private data field according to existing standards would be used for storing item identifier 290. In a variation, a specially defined field for that standard for storing item identifier 290 may be developed and specified. The present specification also includes and contemplates such specially defined fields for storing item identifier 290.

Referring again to FIG. 10, block 525 comprises sending the authorization request prepared at block 520. The destination for the authorization request, now assembled into data stream 600, is based on the contents of the address field 604-2.

Various destination addresses are contemplated, including an address within payment infrastructure 262, or brand server 266, or even to other destinations in network 220, as will be discussed further below.

Block 530 comprises receiving waiting for and receiving an authorization response to the authorization request sent a block 525. If the authorization response is negative, or “no”, then method 500 advances to block 535 where an exception occurs, which is typically in the form of a “transaction declined” message displayed at point of sale terminal 258.

If the authorization response is positive, or “yes”, then method 500 advances to block 535 where an exception occurs, which is typically in the form of a “transaction approved” or “transaction approval” message displayed at point of sale terminal 258.

Note that the authorization response that is received can be an indication that the payment was authorized, as in the usual course and which ignores whether or not item 282 is authentic. Alternatively, the authorization response can be both a payment authorization and authentication response (akin to the kind of determination made at block 410 and block 420), as will be discussed further below in relation to method 700.

Method 500 can also be one way in which payment information is prepared as part of the resulting corresponding performance of block 420, block 425 and block 435.

Note that in variations where the functionality of point of sale terminal 258 is fully or partially incorporated into computing device 254, then method 500 can be performed entirely or partially by computing device 254.

Note that in a variation where some or entire functionality of payment infrastructure 262 is incorporated into the payment card 274 which is implemented as an electronic purse, blocks 520, 530, and 540 can be implemented partially or entirely by the card 274.

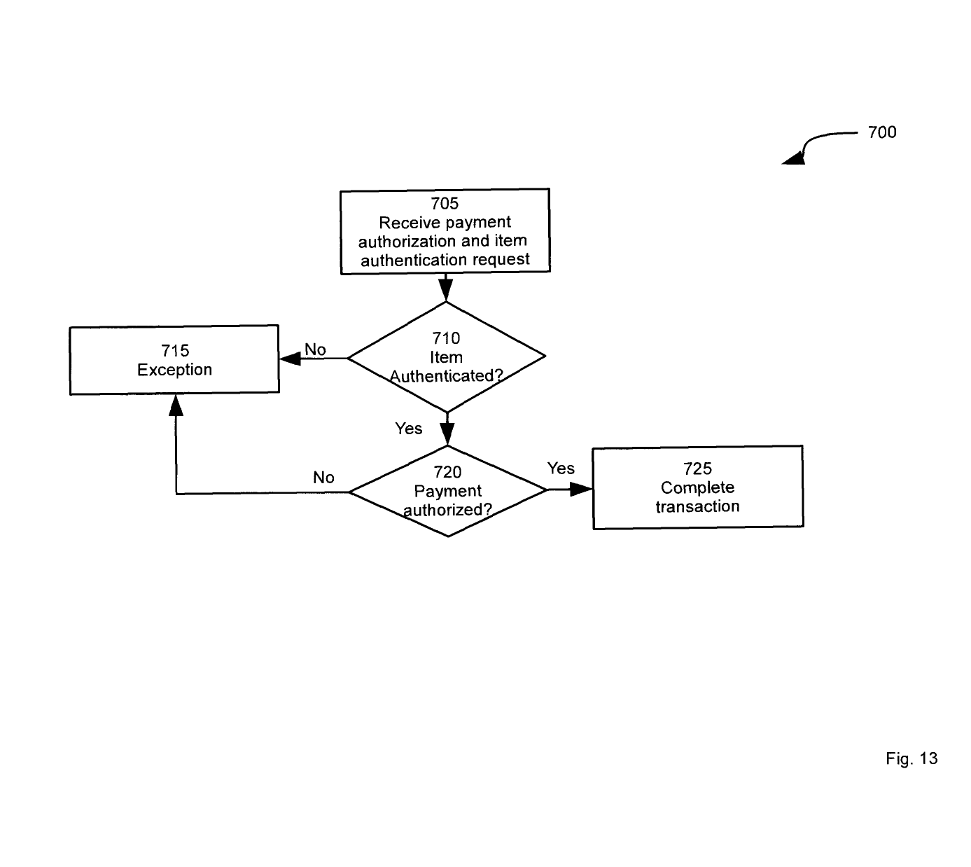

Referring now to FIG. 13, a flowchart depicting another method for brand name and payment authentication is indicated generally at 700. Method 700 is one way in which the authorization message that is sent back to point of sale terminal 258 at block 530 can be prepared. It is to be emphasized, however, that method 700 need not be performed in the exact sequence as shown; and likewise various blocks may be performed in parallel rather than in sequence; hence the elements of method 700 are referred to herein as “blocks” rather than “steps”. In system 250, method 700 can be implemented by brand server 216 working in conjunction with payment infrastructure 262, with messaging and instructions passing therebetween as needed to effect method 700.

Block 705 comprises receiving a payment authorization and item authentication request. Such a request can be received as a result of performance of block 525, when an authorization request is sent. According the example discussed above, block 705 can comprise receiving data stream 600 at a network element having a network address on network 270 that corresponds to the address stored in address field 604-2. In one implementation, brand server 266 receives data stream 600. In another implementation, payment infrastructure 262 receives data stream 600.

Block 710 comprises a determination as to whether the proposed transaction is authorized as it relates to item 282 itself (e.g. is item 282 “authentic”, or is not stolen or subject to some other criteria). In system 250, block 710 is typically performed by brand server 266.

Block 720 comprises a determination as to whether the proposed transaction is authorized as it relates to payment authorization (e.g. does account 278 have sufficient funds? have proper credentials been provided to authorize debiting account 278). “authentic”, or is not stolen or subject to some other restriction). In system 250, block 710 is typically performed by brand server 266. In system 250, block 720 is typically performed by payment infrastructure 262.

A “no” response at either block 710 or block 720 leads to an exception handling block 715. Exception handling block 715, at a minimum, can comprise sending a “transaction declined” message back to point of sale terminal 258 leading to a “no” determination at block 530.

A “yes” determination at block 710 and block 720 leads to block 725 at which point the proposed transaction can be completed, including (i) sending a “transaction approved” message back to point of sale terminal 258 leading to a “yes” determination at block 530; (ii) updating account 278 and (iii) updating record 294 to show the legal transfer of item 282. In certain implementations, the transaction completion will only be effected if all of the foregoing are satisfied.

Note that, advantageously, method 300 can be performed multiple times using device 254 up to the point of performance of method 500 and even after. Thus, assurance of authenticity of item 282 can be ensured at several points up to purchase, and even after purchase. This can be particularly advantageous in shopping environments where fraudulent sales clerks may be inclined to swap the authentic item with a counterfeit item at the point of sale.

While the foregoing provides certain non-limiting example embodiments, it should be understood that combinations, subsets, and variations of the foregoing are contemplated. For example, while the foregoing discussion has been in relation to items of merchandise, it should be understood that the present teachings can be applied to any type of good or service. One example of a service includes the delivery of professional services which are regulated by a governing body. In that example, item identification record 294 can be modified to support a service identification record. Such a service identification record can include a “service provider identifier” rather than an “item identifier” that specifies the identity professional service provider. The service identification record can also include a “governing body identifier” rather than a “manufacturer” identifier. Various other fields in Table I, such as legal owner and location, etc. can be eliminated. The methods described herein would then be modified to authenticate that the service provider, as identified by the service provider identifier, is a member in good standing with the relevant governing body as specified by the governing body identifier. Other ways to structure an item identification record, or a service identification record, will now occur to those skilled in the art. In general, the term “item” as used herein is thus intended to refer to a good or a service.

Still further variants are contemplated. Indeed, in general it should be understood that with the promulgation of cloud computing, the various contemplated processing functions need not be performed by the specific computing elements discussed herein. Indeed, various portions of various methods can be performed on different computing elements. For example, as a variant of brand server 255, item identification instrument 286 can be modified to include a its own processing unit that executes various functions or processes that are otherwise described herein as being performed by brand server 255. For example, identification instrument 286 can be configured to securely store and maintains item description and lifecycle status or other aspects of item identification record 294. As a further example variant portable computing device 254 can be configured to comprise a security element executing some payment infrastructure and payment instrument functions, such as payment transaction authentication or execution, otherwise described herein in relation to payment infrastructure 262. Such variants of embodiments can be used to configure the system allow an “offline” performance of method 250 wherein the item identification instrument 286, the portable computing device 254, the payment instrument 274, and the point of sale 258 communicate with each other, and execute payment transaction, item authentication, and lifecycle status change without sending/receiving data externally at the moment of transaction.

The present specification thus provides a novel system for providing brand assurance and product authenticity. In various circumstances, various advantages afforded by the present specification and will now be apparent, including:

providing assurance that merchandise is genuine

providing assurance at the time of or prior to purchase as opposed to post-purchase

providing assurance directly to the portable devices (Smartphone, personal digital assistant, etc.) thereby bypassing store facilities that may not be trustworthy

tracking the lifecycle of the protected merchandise by making use of the payment card processing infrastructure.

1. A computer-implemented method for source authentication of an item comprising:
receiving a unique item identifier uniquely distinguishing a particular item from any plurality of items, at a computing device;
receiving a payment amount at said computing device corresponding to said item;
receiving electronic payment instructions at said computing device corresponding to said payment amount;
preparing an authorization request message at said computing device comprising said item identifier; said payment amount information and said payment instructions;
sending said authorization request message from said computing device to at least one authorization server;
completing a transaction if a response message to said authorization request message from said at least one authorization server includes an authorization indication, wherein said authorization indication represents that said item is authorized and said payment instructions are authorized.

2. The method of claim 1 wherein said item comprises a good.

3. The method of claim 1 wherein said item comprises a service.

4. (canceled)

5. (canceled)

6. The method of claim 1 wherein said authorization request message is formed according to a standard prescribed by a payment infrastructure authority respective to a payment infrastructure corresponding to said payment instructions.

7. (canceled)

8. (canceled)

9. The method of claim 1 wherein said at least one authorization server comprises a brand server.

10. (canceled)

11. The method of claim 10 9 wherein said brand server is configured to update an item identification record associating said item to an account associated with said payment instructions.

12. The method of claim 1 wherein said at least one authorization server comprises a payment server hosted by a payment infrastructure.

13. (canceled)

14. The method of claim 1 wherein said at least one authorization server comprises a brand server and a payment server hosted by a payment infrastructure.

15. (canceled)

16. The method of claim 1 wherein said unique item identifier is stored on an item identification instrument affixed to or associated with said item.

17. The method of claim 1 wherein said payment instructions are stored on a payment instrument.

18. The method of claim 17 wherein said payment instrument is implemented as a payment card or a proximity transmitter stored within a portable computing device.

19-21. (canceled)

22. The method according to claim 1 further comprising:
receiving said item identifier at a second computing device;
sending said item identifier from said second computing device to an authorization server;
receiving at said second computing device from said authorization server a set of data describing the item;
generating said set of data on an output device of said second computing device;
receiving at an input device of said second computing device, in response to said generating, input representing consent or a denial of consent;
receiving by said authorization server said input representing consent or said denial of consent; and
declining authorization at said authorization server if:
said item identifier sent by said second computing device does not match said item identifier sent by said computing device; or said input represents a denial of consent; and
providing authorization at said authorization server if said input represents consent.

23. The method of claim 22 further comprising sending notification of transaction completion from said authorization server to said second computing device.

24. The method of claim 22 wherein said second computing device incorporates said payment instrument.

25. The method of claim 22 wherein said second computing device comprises some or all elements of said computing device.

26. The method of claim 16 wherein
said item identification instrument comprises an integrated circuit payment card in any form factor;
said unique item identifier comprises some data elements associated with or stored in said integrated circuit payment card; and
said brand server comprises a server of the issuer of said integrated circuit payment card.

27. The method of claim 1 wherein
said transaction starts before conveyance of said item;
said authorization consent is sent upon conveyance of said item; and
said transaction completes upon said item being conveyed.

28. The method of claim 27 wherein said item is a product and said conveyance comprises shipping said product.

29. The method of claim 27 wherein said item is a service and said conveyance comprises performance of said service.

30. The method of the claim 27 wherein completion of said transaction occurs on a third computing device, the third computing device present at the point of said item delivery.

31. (canceled)
